(19) United States
(12) Patent Application Publication
(10) Pub. No.: US 2005/0207951 A1
(43) Pub. Date: Sep. 22, 2005

(54) Air sterilizer using ozone

(75) Inventors: Jae-Shin Lee, Ulsan (KR); Jae-Seok Park, Ulsan (KR); Hong-Il Chae, Pusan (KR); Dae-Woo Choi, Ulsan (KR)

Correspondence Address: BACON & THOMAS, PLLC, 625 SLATERS LANE, FOURTH FLOOR, ALEXANDRIA, VA, 22314, US

(73) Assignee: SMART AIR INC., Ulsan (KR)

(21) Appl. No.: 10/510,960

(22) PCT Filed: May 1, 2003
(86) PCT No.: PCT/KR03/00879

§ 371 Date: Nov. 1, 2004

(30) Foreign Application Priority Data
May 1, 2002 (KR) 10-2002-0023904
Apr. 30, 2003 (KR) 10-2003-0027391

(51) Int. Cl. B01J 19/08; B01J 19/12

(52) U.S. Cl. 422/186.07; 422/186.15

(57) ABSTRACT

The present invention relates to an apparatus for efficiently deodorizing or sterilizing a target space, which is contaminated with virus, bacteria, fungi and the like over a reference value, by using ozone without adversely affecting a human body. More particularly, the present invention relates to an air sterilizer using ozone, which includes a control unit for automatically controlling a proper concentration of ozone capable of efficiently sterilizing the target space according to the size of the target space. Specifically, the air sterilizer comprises an ozone generating unit subjected to ON/OFF control, a control unit for controlling a variety of safety devices having functions of efficiently controlling the concentration of ozone in the target space, a functional air filter unit having functions of cleaning air and removing residual ozone, and a fan for circulating the air in the target space. According to the air sterilizer of the present invention, virus, bacteria and fungi floating in the air can be more efficiently removed over conventional air cleaner and a malodor source can also be eliminated.

### TECHNICAL FIELD

The present invention relates to an air sterilizer using ozone for performing an air cleaning function based on superior deodorizing and sterilizing power of the ozone. More particularly, the present invention relates to an air sterilizer using ozone, which has functions of recognizing the size of a target space, performing control for causing the concentration of ozone in the target space to be maintained at a proper value in order to achieve efficient deodorization and sterilization, detecting a human body during and after a sterilizing operation, and removing residual ozone from the target space.

### BACKGROUND ART

Generally, ozone is a faint blue gas of peculiar smell and performs functions of sterilization, disinfection and bleaching. Ozone generators using such properties of ozone have been applied to widely used air sterilizers and employed in a variety of fields including purification of wastewater and contaminated air and sterilization of foodstuffs.

Ozone is an allotrope of oxygen, which comprises three bonded oxygen atoms. The ozone is generated through processes of bonding and dissociation between unstable carbides or nitrides among exhaust gas generated due to incomplete combustion in automobiles, or through excitation of oxygen molecules O₂, which exists in the atmosphere in the amount of about 20%, produced while solar energy strongly reaches the earth's surface due to depletion of the ozone layer that exists in an outer portion of the earth. Although the ozone may be generated even in a natural state in such a way, it may be artificially generated by using various methods such as an electrolytic method, a photochemical method, a corona discharge method, an ultra-violet radiation method and a soundless discharge method. Recently, the ozone is artificially generated and employed in a variety of fields by applying energy such as electrical discharge to oxygen molecules in order to utilize the powerful sterilizing and deodorizing power of the ozone. The ozone began to be applied to a field related to the quality of water from before one hundred years and is recently discussed in order to technically apply it to an atmosphere application field based on living malodor and bacteria.

Generally, when contaminants, i.e. target substances to be removed, distributed in a space are classified according to their sizes, the size of dust particles is few microns to several decade microns, the size of fungi is about 5 μm, the size of bacteria is in a range of 0.5 to 10 μm, and the size of virus is 0.1 μm or less. A conventional air sterilizer with an electric ionizer has the following problems.

First, most of existing air purifiers or air cleaners generally include predetermined electric ionizers in order to remove fungi or bacteria contained in introduced air. However, since they employ a method of removing limited target bacteria adhering to air filters through the circulation of air in a target space or preventing the target bacteria from being propagated by using antibacterial filters rather than a method of efficiently performing deodorization and sterilization in the target space, their sterilizing power is low. Further, since they substantially rely on multifunctional air filters, the spaces occupied by the air filters are relatively large in the equipment. Thus, it is difficult to miniaturize the equipment, and the efficiency of air circulation in the target space is lowered because the air filters themselves function as resistance components to the circulating air. Accordingly, there is a disadvantage in that air within a space with a volume prescribed by standards cannot be efficiently cleaned.

Moreover, in a circulating air filtering method employed in an existing air cleaner, particulate dust and fungi can be removed by means of an air filter. However, if a fine air filter is used to capture or remove bacteria or virus, there are disadvantages in that the efficiency of circulation of air in a target space is lowered and time required for cleaning the air is substantially lengthened.

Furthermore, since the air filter is secondarily contaminated during the process of cleaning the air, replacement and management thereof should be thoroughly performed. There is also a disadvantage in that fine microbes such as bacteria and virus which cannot be filtered out by the air filter are partially removed or never removed. In the meantime, an existing apparatus for sterilizing air in a target space by directly using ozone does not control the ozone in the target space to be maintained at a proper concentration. Thus, there is an objection thereto raised on the grounds that it may affect a human body.

Korean Patent Laid-Open Publication No. 10-1998-83611 discloses a configuration in which if a person approaches a target space, which has the concentration of ozone beyond a predetermined value, for a long time within a range of predetermined distance, the approach is detected by using supersonic waves and a warning sound is issued so that a user can quickly cope with the situation and safety accidents can be accordingly reduced. However, this configuration is not to automatically control the concentration of ozone in the target space to be maintained at a proper level but merely to temporarily reduce safety accidents due to excess ozone in the atmosphere by issuing the warning sound in a case where a person is in the vicinity of an ozone generator.

Further, there is an air sterilizing method by which air in a target space is introduced into an apparatus and then sterilized on an air moving path in the apparatus without discharging ozone harmful to a human body directly to the target. However, the method has disadvantages in that the size of the apparatus itself should be increased in order to capture the air, the life of a catalytic filter for removing residual ozone remaining after cleaning the air in the apparatus is shortened, and the effect of sterilizing the air of the target space is lowered as a whole.

### SUMMARY OF INVENTION

The present invention is conceived to solve the aforementioned problems. An object of the present invention is to provide an air sterilizer using ozone, which has an air cleaning function capable of completely eliminating an influence of the ozone on a human body by controlling the concentration of ozone to achieve efficient deodorization and sterilization of air in a target space.

Another object of the present invention is to provide an air sterilizer using ozone, which is designed to completely eliminate a harmful influence of the ozone on a human body by causing the air sterilizer to be automatically operated according to whether there is a person in a target space.

A further object of the present invention is to provide an air sterilizer using ozone, which recognizes the size of a target space and causes the concentration of ozone to be maintained at a proper concentration for efficient deodorization and sterilization of air in the target space.

A still further object of the present invention is to provide an air sterilizer using ozone, which can perform deodorization and sterilization of air in a target space under the concentration of ozone harmless to a human body even though a person is in the target space, by controlling the concentration of ozone according to the activity of human body.

According to the present invention for achieving the objects, there is provided an air sterilizer using ozone, which operates in one or more modes of a standby (cleaning) mode, a deodorization mode and a sterilization mode. The air sterilizer comprises an ozone generating unit for generating the ozone in the deodorization or sterilization mode, an ozone sensor for detecting the concentration of ozone in a target space, and a control unit for controlling the operation of the ozone generating unit according to the concentration of ozone in the target space detected by the ozone sensor.

### BRIEF DESCRIPTION OF DRAWINGS

FIG. 1 is a view showing a configuration of the air sterilizer using ozone according to the preferred embodiment of the present invention.

FIG. 2a is a view showing an example of a period of the ON/OFF switching operation of the ozone generating unit and FIG. 2b is graphs showing relationships between the increasing rates of the concentration of ozone according to the size of the target space and the operating times of the ozone generating unit.

FIG. 3 is a graph showing a relationship between time and an output level detected by the human body sensor.

FIG. 4 is a flowchart illustrating setting of the operating condition in the sterilization mode among the operating modes of the air sterilizer of the present invention.

FIG. 5 is a flowchart illustrating the operating condition of the ozone generating unit of the air sterilizer of the present invention that operates in the deodorization mode.

FIG. 6 is a block diagram generally showing the operation of the air sterilizer according to the present invention, and basically shows some components of the air sterilizer shown in FIG. 1 and the cooperative relationship among them.

### DETAILED DESCRIPTION OF THE PREFERRED EMBODIMENT

Hereinafter, an air sterilizer using ozone according to a preferred embodiment of the present invention will be described in detail with reference to the accompanying drawings.

FIG. 1 is a view showing a configuration of the air sterilizer using ozone according to the preferred embodiment of the present invention. As shown in FIG. 1, the air sterilizer using ozone comprises an inlet 90 through which air in a target space is sucked, air filter unit 70 for removing dust, outlet 30 for discharging the air to the outside, ozone generating unit 20 including a discharge portion (not shown) for generating the ozone, ozone sensor 80 for detecting the concentration of ozone in the target space, human body sensor 50 for determining the presence of a person in the target space and the activity of human body, printed circuit board (PCB) 60 of an operating unit in which a user selects one of a standby (cleaning) mode, a deodorization mode and a sterilization mode of the sterilizer, sirocco fan 10 for circulating the sucked air in the air sterilizer, and control unit 40 for controlling entire operations of the air sterilizer.

The air sterilizer further comprises logic circuit unit 41 for calculating a variety of data to achieve a proper deodorization or sterilization concentration based on the concentration of ozone detected by ozone sensor 80, and first and second memory means 43 and 45 for storing data and the like calculated in ozone sensor 80 and logic circuit unit 41.

Control unit 40 controls the ozone generating operation of ozone generating unit 20 so that the concentration of ozone in the target space can reach the proper deodorization or sterilization concentration. Ozone generating unit 20 generates the ozone while performing switching operations with predetermined ON/OFF intervals.

The operations of the air sterilizer using the ozone according to the present invention shown in FIG. 1 will be explained below according to the respective operation modes. As described above, air sterilizer 1 of the present invention operates in the three modes, i.e., standby (cleaning) mode, deodorization mode and sterilization mode. The respective modes are manipulated according to the selection by the user through PCB 60 of the operating unit. The standby (cleaning) mode means a standby operation mode or an air cleaning operation mode of the air sterilizer, the deodorization mode means a deodorizing operation mode for removing a malodor source from the target space, and the sterilization mode means a sterilizing operation mode for removing a contamination source from the target space.

First, in the standby (cleaning) mode, the air sucked toward inlet 90 by means of the operation of sirocco fan 10 is sequentially subjected to dust removal and deodorization while passing through air filter unit 70. Then, the air passes by sirocco fan 10 and is discharged toward outlet 30. Further, in the deodorization or sterilization mode to be described below, if the concentration of ozone in the target space exceeds a set value, the generation of the ozone is stopped and the mode is changed to the standby (cleaning) mode. Then, a series of operations for removing residual ozone in the target space is performed.

The operations in the deodorization mode are basically identical with those in the standby (cleaning) mode. Additionally, ozone sensor 80 operates on the side of inlet 90, and ozone generating unit 20 discharges a small amount of ozone through outlet 30 to the target space by means of the ON/OFF switching. At an initial stage of the deodorization mode, the ozone sensor 80 recognizes the target space. Logic circuit unit 45 calculates an operating time and condition of ozone generating unit 20 based on the recognized results. Information data for use in calculating the operating time and condition of ozone generating unit 20 may include data on the concentration of ozone in the target space C generated from ozone generating unit 20, data on time duration of generation of the ozone T, and data on an air volume W, and the like. A specific example of the processes of recognizing the target space and calculating the operating time and condition will be described later.

According to the calculated operating time and condition, ozone generating unit 20 discharges ozone until the concentration of ozone reaches a proper deodorization concentration. Such a small amount of ozone discharged circulates in the target space. Ozone sensor 80 positioned at inlet 90 performs a function of detecting the concentration of ozone. If ozone sensor 80 detects that the concentration of ozone in the target space exceeds the set value, control unit 40 stops the operation of ozone generating unit 20 so that the ozone cannot be generated. The operation mode of the air sterilizer is automatically changed from the deodorization mode to the standby (cleaning) mode. In this case, the air sterilizer continuously operates for a predetermined period of time in the standby (cleaning) mode in order to remove residual ozone in the target space. It was found from test results that when a discharge air volume from the outlet was 5 to 6 CMM in a target space of 99 m² (30 Pyeong), the ozone sensor 80 detected a set concentration of 0.03 to 0.06 ppmv within 3 to 15 minutes after start of the operation of the ozone generating unit, control unit 40 stopped the ozone generating operation by controlling ozone generating unit 20 simultaneously with the detection, and residual ozone was then completely removed from the target space through the operations in the standby (cleaning) mode for about 2 hours.

In the deodorization mode, the ozone discharged to the target space circulates in the target space for a predetermined period of time. If there is a malodor source in the target space, a reaction between the ozone and the malodor source prevents the concentration of ozone from being increased. If the malodor source is eliminated after a certain period of time, the concentration of ozone in the target space is above the set value due to residual ozone that has not yet reacted with the malodor source. At this time, the operation mode of the air sterilizer is changed from the deodorization mode to the standby (cleaning) mode. The ozone sucked through inlet 90 in the cleaning mode is processed by a carbon filter (not shown) disposed at a final stage of air filter unit 70. Thus, the residual ozone in the target space can be removed.

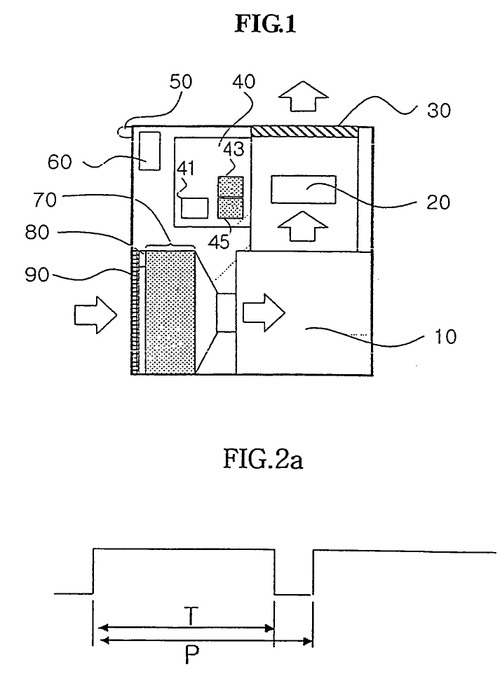

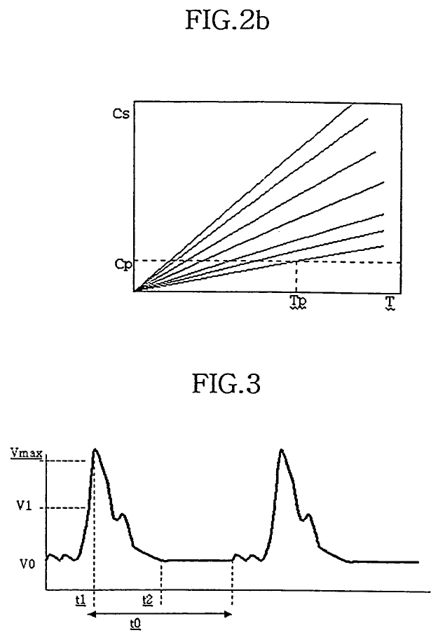

FIG. 2a is a view showing an example of a period of the ON/OFF switching operation of the ozone generating unit. The space recognizing operation of ozone sensor 80 uses the ON/OFF switching operation of ozone generating unit 20 and is performed by detecting an increasing rate of the concentration of ozone in the target space during the ON time of ozone generating unit 20. In FIG. 2a, a duration from a rising edge to a falling edge is the ON time of ozone generating unit 20, and a duration from the falling edge to the next rising edge is the OFF time of ozone generating unit 20. As shown in FIG. 2a, assume that the ON/OFF switching period of ozone generating unit 20 is P and the ON time of ozone generating unit 20 is T, an ON-time ratio R can be defined as TIP. If the ON time of ozone generating unit 20 during the switching operation thereof is lengthened, the ratio R is increased. On the contrary, if the ON time is shortened, the ratio R is decreased. If the size (volume) of the target space is constant, a reference operating time T_{P} of ozone generating unit 20 during which the concentration of ozone C in the target space reaches a predetermined reference concentration of ozone C_{P} is shortened as the ratio R is increased. FIG. 2b shows graphs showing relationships between the increasing rates of the concentration of ozone according to the size of the target space and the operating times of the ozone generating unit. At an initial stage of the operation of the air sterilizer, data on a plurality of ON-time ratios (R=T/P) are obtained while the operating time T of ozone generating unit 20 in the target space is changed. As shown in FIG. 2b, the ON-time ratios R obtained from the graphs with two axes of the concentration of ozone C in the target space and the operating time T of ozone generating unit 20 are exhibited as gradients of the graphs. The gradient of each of the ON-time ratios R can be exhibited on the relevant graph by actually measuring the reference operating time T_{P} required for reaching the reference concentration of ozone C_{P}. Referring to the graphs shown in FIG. 2b, as the ON-time ratio R is high, i.e. the gradient is large, the reference operating time T_{P} required for reaching the reference concentration of ozone C_{P} is shortened. Here, the reference concentration of ozone C_{P} or reference operating time T_{P} is reference data that can be arbitrarily selected. In an embodiment of the present invention, the reference concentration of ozone is set to 0.03 to 0.06 ppmv. When the ozone is generated through the ON/OFF switching operation with a selected ON time in ozone generating unit 20, i.e. ozone generating unit 20 is operated at a selected ON-time ratio R, it is possible to measure the size of the target space by measuring the reference operating time T_{P} required for reaching the predetermined reference concentration of ozone C_{P}. Here, the operation of recognizing the size of the target space may be an operation performed only when the air sterilizer of the present invention initially operates in a specific space. Alternatively, an applicable range of the air sterilizer can be extended by calculating ON-time ratios R and making them be used as data while changing the operating times T in other spaces.

Further, the logic circuit unit 45 calculates data on the time T_{P} from start of the operation of the ozone generating unit to when the concentration of ozone detected by the ozone sensor reaches the predetermined reference concentration of ozone C_{P}. If a ratio between the operating time T of ozone generating unit 20 and the reference operating time T_{P} is below a predetermined value, the control unit controls the ozone generating unit such that the ON-time ratio R can be decreased. That is, ozone generating unit 20 performs a switching operation with a short ON time in a relatively small space (a ratio of T_{P}/T is below 0.5). On the contrary, it performs a switching operation with a long ON time in a relatively large space (a ratio of T_{P}/T is 0.5 or more). This is to ensure stable supply of ozone by applying a proper ON time ratio R according to the size of a target space in consideration of the characteristic that a large ratio of T_{P}/T allows the space to be recognized for a short time but causes a large error range, whereas a small ratio of T_{P}/T causes time required for recognizing the space to be increased but an error range to be narrowed. As an example, upon generation of the ozone, a more accurate recognition of a space can be achieved by increasing the concentration of ozone in a target space while slightly changing an ON-time ratio R up to a concentration of start of deodorization and sterilization Cs.

Operating condition data such as the data on the operating time T, ON/OFF switching period P and ON-time ratio R obtained through such a space recognizing operation are stored, together with data on the size of the target space corresponding to the operating condition data, in first memory means 43. Control unit 40 controls the operation of ozone generating unit 20 by referring to the operating condition data stored in first memory means 43 so that ozone can be optimally generated according to the size of the target space.

Next, the sterilization mode will be discussed. When a user presses a sterilization mode operating button (not shown) connected to PCB 60 of the operating unit, a sound signal for informing the user of the operation in the sterilization mode is output as a warning signal for causing the user to escape from the target space. After a predetermined standby time passes, the human body sensor (IR sensor) operates and detects whether a human body exists in the target space. If any human body is not detected, the sterilization mode is activated. At an initial stage of the operation in the sterilization mode, the space recognizing operation for the target space and the operation of calculating the operating time and condition of ozone generating unit 20 are performed in the same manner as the deodorization mode. Accordingly, detailed descriptions thereof will be omitted. The air sucked through inlet 90 is sequentially filtered by air filter unit 70, and ozone sensor 80 disposed on the side of inlet 90 detects, in real time, the concentration of ozone in the target space in order to maintain a proper concentration of ozone for efficient sterilization of the target space. Ozone sensor 80 sends control unit 40 a signal corresponding to the detected concentration of ozone. Control unit 40 sends ozone generating unit 20 an output signal for controlling ON/OFF of ozone generating unit 20 in response to the signal received from ozone sensor 80. At this time, by using a time when the concentration of ozone in the target space reaches a specific concentration of ozone, preferably a concentration of 0.03 to 0.06 ppmv that is below a reference value of the concentration of ozone harmful to a human body, the operating time T of ozone generating unit 20 required for reaching an optimum concentration of 0.1 to 0.15 ppmv for sterilizing the target space set in the air sterilizer of the present invention through tests, and a predetermined condition (hereinafter, referred to as “operating condition”) set through sufficiently repeated tests according to the size and environmental factors of the target space, preferably the state of floating matters, temperature, humidity, physical environment of the target space (under or above the ground), and convection in the target space (hereinafter, referred to as “environmental information), which are factors having an influence on the concentration of ozone in the atmosphere, are estimated and then input as internal data into the control unit of the air sterilizer.

The air sucked through inlet 90 passes through multistage air filter unit 70 and circulates in the air sterilizer by means of fan 10 disposed within the air sterilizer. The air circulating in the air sterilizer is mixed with ozone while passing through an ozone discharging unit (not shown) disposed between fan 10 and a grill of outlet 30, and exits through outlet 30. The ozone discharged into the target space sterilizes the target space, and control unit 40 controls ON/OFF of ozone generating unit 20 according to the operating time and condition of ozone generating unit 20.

Further, since the air sterilizer of the present invention operates in cooperative with the human body sensor for detecting a human body in the target space, the air sterilizer issues a warning message or emergency bell sound requesting ventilation upon detection of the human body and at the same time its operation mode can be automatically changed to the standby (cleaning) mode for removing residual ozone. When the operation in the sterilization mode is completed, the air sterilizer issues an alarm for indicating the completion of the sterilization and at the same time continuously operates in the standby (cleaning) mode in order to remove the residual ozone generated due to the sterilization operation.

FIG. 3 is a graph showing a relationship between time and an output level detected by the human body sensor.

The human body sensor determines the activity of human body Y by converting the degree of detecting a human body in the target space into a detecting distance D and the frequency of detecting a human body N. Based on the activity of human body Y, it is possible to control the concentration of generated ozone C, an ozone generating time T and an air volume W, which are operating conditions for sterilization and deodorization in a specific space.

First, sterilization (deodorization) power S in a target space is defined as the following formula 1:
S≈f(C,t), (1)
where C is the concentration of generated ozone and t is a generating time.

As can be seen from Formula 1, the sterilization (deodorization) power S is increased as the concentration of generated ozone C and the generating time t are increased. The activity of human body Y is defined as the following formula 2 expressed by using the sterilization (deodorization) power S:

$$Y ≅ \frac{W}{S} ≅ \frac{W}{f ( C , t )} , \qquad ( 2 )$$

where W is an air volume. The activity of human body Y varies with the sterilization (deodorization) power S and the air volume W. That is, the activity of human body Y is in inverse proportion to the sterilization (deodorization) power S and in proportion to the air volume W. However, this is applied only to fuzzy sterilization (deodorization). In the fuzzy cleaning, as the activity of human body Y is increased, the air volume W is decreased and the sterilization (deodorization) power S is not involved therein.

Meanwhile, an output characteristic according to the detecting distance D of the human body sensor is expressed as the following formula 3 by referring to the graph shown in FIG. 3:

$$D ≅ K \frac{( V1 - V0 )}{( V max - V0 )} . \qquad ( 3 )$$

Formula 3 utilizes a characteristic that the human body sensor has different output voltage levels according to the detecting distance D, and means that a human body is closer thereto as the output voltage level is higher. K is a reference constant value for a maximum detecting distance of the human body sensor (e.g., if the maximum detecting distance of the human body sensor is 5 m, K is 5). Thus, D is smaller than or equal to K. For example, if a human body sensor with K of 5 is used and V1 is 1/2Vmax, the detecting distance D is 2.5 m. Therefore, it can be understood that the detecting distance D of the human body sensor has higher availability as the output voltage level is higher.

The following formula 4 indicates the frequency of detecting the human body:

$$N ≅ \frac{\sum [ \frac{( t2 - t1 )}{t0} ]}{n} . \qquad ( 4 )$$

Considering Formula 4 together with Formula 3, it can be understood that the human body sensor does not output a continuous signal upon detection of the human body but outputs a discrete signal according to the positional movement of the human body as shown in FIG. 3. In Formula 4, the frequency of detecting the human body N cannot exceed 1 to the utmost and has a value between 0 and 1.

Therefore, the activity of human body Y can be expressed as the following formula 5 by combining Formulas 1 to 4:

$$Y ≅ \frac{D}{N} * 100. \qquad ( 5 )$$

As can be seen from Formula 5, the activity of human body Y is in inverse proportion to the frequency of detecting the human body N and in proportion to the human body detecting distance D. Further, as can be seen from Formula 2, the activity of human body Y is in inverse proportion to the sterilization power S for a fuzzy sterilization function.

The logic circuit unit 41 calculates the activity of human body Y through an operation based on Formula 5 by using the calculated detecting distance D and the frequency of detecting the human body N. The second memory means 45 stores the activity of human body Y, data on a proper concentration of ozone C corresponding to the activity of human body Y, data on ozone generating duration TD, and data on the air volume W. Accordingly, the control unit 40 can control the operation of the ozone generating unit 20 based on he calculated activity of human body. For example, when it is intended to perform sterilization or deodorization in a state where a person is in the target space, the control unit can control the generation of the ozone such that the concentration of ozone in the target space is maintained below a concentration harmful to a human body.

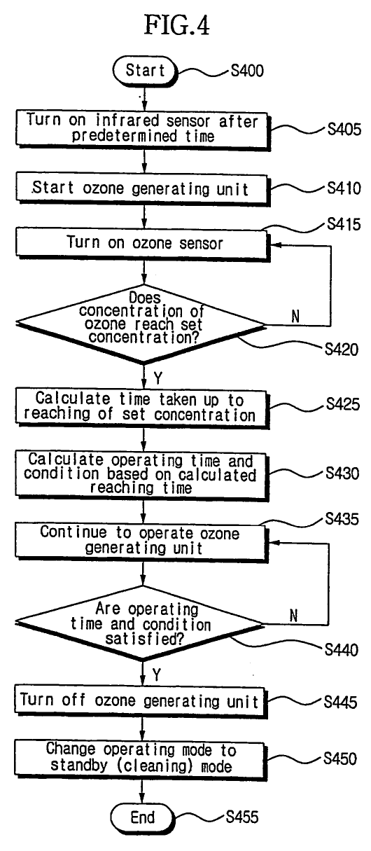

FIG. 4 is a flowchart illustrating setting of the operating condition in the sterilization mode among the operating modes of the air sterilizer of the present invention. Once the air sterilizer begins to operate, a vocal guidance message such as “A sterilization operation will be performed after 5 minutes. Please escape from the room.” is issued so that persons staying in the target space can disperse for a predetermined period of time. After the predetermined dispersing period of time passes, the human body sensor, the ozone generating unit and the ozone sensor are turned on (steps 405 to 415). As the ozone is generated from the ozone generating unit, the concentration of ozone in the target space detected by the ozone sensor 80 is increased. The ozone sensor 80 detects the concentration of ozone in the target space and determines whether it reaches a set concentration (step 420). If it is determined that the concentration of ozone detected by the ozone sensor 80 has reached the set concentration, the target space recognizing operation of calculating a time from the start of the operation of the ozone generating unit to when the concentration of ozone reached the set concentration is performed (step 425). Based on the calculated time, the logic circuit unit included in the control unit 40 calculates the operating time and condition of the ozone generating unit according to predetermined environmental information (step 430). Then, it is determined whether the operation of the ozone generating unit meets the calculated operating time and condition (step 440). If the calculated operating time has elapsed or the operation of the ozone generating unit meets the operating condition, the ozone generating unit is turned off (step 445). Thereafter, the operating mode of the air sterilizer is changed from the sterilization mode to the standby (cleaning) mode (step 550) and the sterilization mode is terminated (step 455). If a human body is detected in the target space during the operation of the ozone generating unit by using an additional human body sensor while imparting the operating condition of the ozone generating unit in such a process, the ozone generating unit is turned off while an alarm is issued regardless of the setting of the operating condition as described above. The operating mode of the air sterilizer is changed from the sterilization mode to the standby (cleaning) mode.

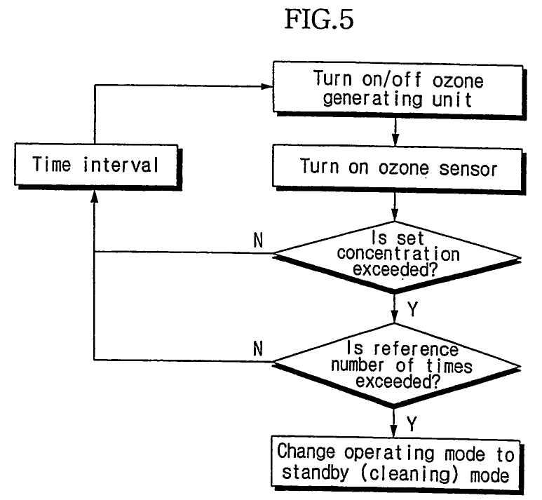

FIG. 5 is a flowchart illustrating the operating condition of the ozone generating unit of the air sterilizer of the present invention that operates in the deodorization mode.

The flowchart of FIG. 5 relates to a method of controlling the concentration of ozone in the target space in the deodorization mode. To control a small amount of ozone, for example, if the concentration of ozone is below a set value of 0.05 ppmv, the ON/OFF operation of ozone generating unit 20 is kept continuous. It is determined whether the number of times of ON/OFF operation exceeds the predetermined reference number of times of ON/OFF operation in a case where the concentration of ozone in the target space is above the set value. If the number of times of ON/OFF operation exceeds the predetermined reference number of times of ON/OFF operation, the operation mode of the air sterilizer is automatically changed from the deodorization mode to the standby (cleaning) mode. According to the flowchart illustrated in FIG. 5, even in a case where the concentration of ozone in the target space exceeds the set value, a minimum of generation of the ozone is ensured by the predetermined reference number of times required for the deodorization. Thus, efficient deodorization of the target space can be achieved. That is, if the concentration of ozone in the target space exceeds the set reference value of 0.05 ppmv at the first operation of the ozone generating unit after start of the operation thereof, ozone generating unit 20 stops temporarily. However, if the concentration of ozone in the target space detected by ozone sensor 80 does not exceed the set reference value at the second operation of the ozone generating unit, ozone generating unit 20 operates again. Consequently, if the detected concentration of ozone in the target space does not consecutively exceed the set reference value over the predetermined reference number of times, ozone generating unit 20 continues to perform the ON/OFF operation. In such a way, the concentration of ozone in the target space is detected every one operation cycle. For example, if the concentration of ozone in the target space consecutively exceeds the reference value three or more times, the operating mode of the air sterilizer is changed from the deodorization mode to the standby (cleaning) mode. Even in this case, if the concentration of ozone in the target space is above a set concentration of 0.06 ppmv, which is determined as being harmful to a human body, due to ozone discharged from the air sterilizer operated in the deodorization mode even though the concentration of ozone in the target space does not consecutively exceed the reference value over the predetermined reference number of times, the operation of ozone generating unit 20 is stopped and the operating mode of the air sterilizer is changed from the deodorization mode to the standby (cleaning) mode.

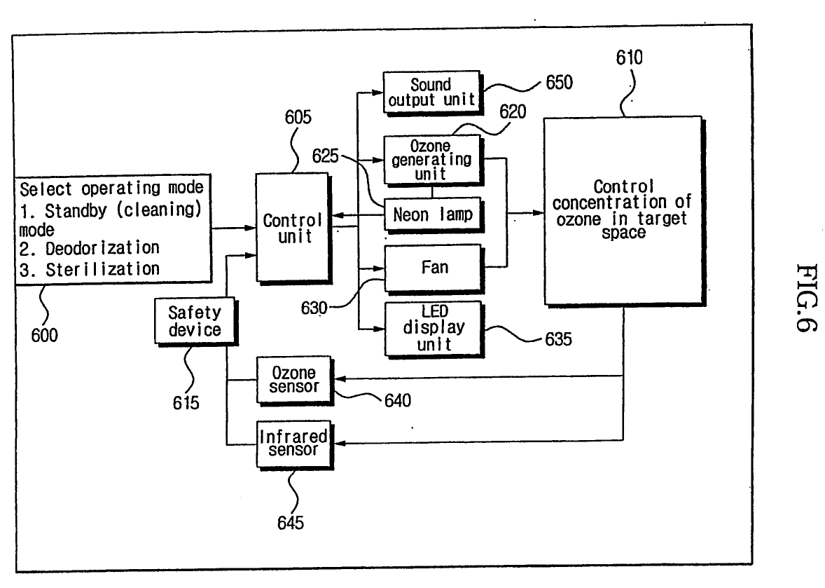

FIG. 6 is a block diagram generally showing the operation of the air sterilizer according to the present invention, and basically shows some components of the air sterilizer shown in FIG. 1 and the cooperative relationship among them. Operating mode selection unit 600 allows a user to select the operating mode of the air sterilizer using ozone according to the present invention. When the user selects one of the operating modes, a signal is input into control unit 605 and the overall system (ozone generating unit, fan, LED display unit, ozone sensor, human body sensor, neon lamp, sound output unit, etc.) is operated. Based on the selected operating mode, control unit 605 for controlling the entire operation of the air sterilizer performs the control of the concentration of ozone in target space 610 by controlling ozone generating unit 620 and fan 630. The concentration of ozone in the target space is detected by ozone sensor 640 and fed-back to control unit 605. Control unit 605 again controls ozone generating unit 620 and fan 630 so as to maintain a proper concentration of ozone in the target space. As for neon lamp 625 shown in FIG. 6, if a high-voltage transformation unit (not shown) included in ozone generating unit 620 operates normally, gas in neon lamp 625 is discharged due to an electromagnetic field of the high-voltage transformation unit to turn on the neon lamp. The ON signal is transmitted to control unit 605 so that the normal operation of ozone generating unit 620 can be confirmed. If there is malfunction of ozone generating unit 620, neon lamp 620 is intermittently turned on and off. When such a signal of neon lamp 625 is applied to control unit 605, control unit 065 stops the operation of ozone generating unit 620.

According to the embodiment of the present invention shown in FIG. 6, ozone sensor 640 and human body sensor 645 are connected to control unit 605 through safety device 615. Safety device 615 of FIG. 6 is to make provision for abnormal transmission and reception of a signal of control unit 605 itself. For example, if ozone sensor 640 is out of order, the proper concentration of ozone in the target space cannot be performed normally. In this case, safety device 615 detects whether an operating voltage of ozone sensor 640 is constant so as to determine whether ozone sensor 640 operates normally. If an abnormal operation of ozone sensor 640 is detected, safety device 615 operates and control unit 605 causes a diagnostic lamp of LED display unit 635 to be turned on so that the user can recognize that the ozone sensor is out of order. That is, safety device 615 and ozone sensor 640 operate in such a manner that they bi-directionally communicate with control unit 605. Further, human body sensor 645 detects whether there is a human body in the target space and sends a predetermined signal based on the detected results. If human body sensor 645 is out of order, it is impossible to perform a sterilization operation harmless to a human body. In this case, if an abnormal operation of human body sensor 645 is detected, safety device 615 operates and control unit 605 causes the diagnostic lamp of LED display unit 635 to be turned on so that the user can recognize that the human body sensor is out of order, in the same manner as ozone sensor 640 described above. Sound output unit 650 of FIG. 6 outputs the operating state of the air sterilizer using ozone according to the present invention in the form of one of stored sounds under the control of control unit 605, so that the user can be informed of the current operating state of the air sterilizer.

Although the air sterilizer using ozone according to the present invention has been described in detail with reference to the accompanying drawings, it will be apparent to those skilled in the art that various changes and additional embodiments can be made based on the details of the preferred embodiment of the present invention.

### INDUSTRIAL APPLICABILITY

According to the air sterilizer using ozone of the present invention, the concentration of ozone is controlled to achieve efficient deodorization and sterilization of a target space, so that the target space can be deodorized and sterilized while harmful effects which may be exerted on a human body are excluded. Further, there is a technical advantage in that an air cleaning function is additionally provided.

Moreover, according to the air sterilizer using ozone of the present invention, since the sterilization operation of the air sterilizer for the target space is automatically performed depending on the presence of a human body in the target space, there is a technical advantage in that harmful effects of the ozone exerted on the human body can be completely excluded.

Furthermore, according to the air sterilizer using ozone of the present invention, since the size of the target space is recognized, there is a technical advantage in that a proper concentration of ozone for efficient deodorization and sterilization of the target space can be maintained.

In addition, there is a technical advantage in that even in a case where a user exists in the target space, the target space can be deodorized if necessary while the concentration of ozone in the target space is controlled to be maintained below 0.06 ppmv that is a threshold value harmful to a human body.

Although the present invention has been described in connection with the preferred embodiment of the present illustrated in the accompanying drawings, it is not limited thereto. It will be apparent to those skilled in the art that various changes and modifications can be made thereto based on the descriptions herein. Therefore, the spirit and scope of the present invention should be construed as being defined by the appended claims. Equivalents thereof will fall within the scope of the present invention.

1. An air sterilizer using ozone, wherein:
the air sterilizer operates in one or more modes of a standby (cleaning) mode, a deodorization mode and a sterilization mode, and
the air sterilizer comprises:
an ozone generating unit for generating the ozone in the deodorization or sterilization mode,
an ozone sensor for detecting the concentration of ozone in a target space, and
a control unit for controlling the operation of the ozone generating unit according to the concentration of ozone in the target space detected by the ozone sensor.

2. The air sterilizer as claimed in claim 1, wherein the control unit controls the ozone generating unit such that the ozone is generated through switching operations of the ozone generating unit at a predetermined ON/OFF period and thus the concentration of ozone in the target space can reach a predetermined concentration of ozone for deodorization of sterilization.

3. The air sterilizer as claimed in claim 2, wherein if the concentration of ozone detected by the ozone sensor exceeds a predetermined concentration, the control unit stops the operation of the ozone generating unit and performs control for change of the operating mode to the standby (cleaning) mode.

4. The air sterilizer as claimed in claim 2, further comprising a logic circuit unit for calculating the size of the target space by calculating one or more of data on an operating time (T) of the ozone generating unit, an OF/OFF switching period (P) of the ozone generating unit and an ON time ratio (R) of the switching period (P), which are required for achieving the predetermined concentration of ozone for deodorization or sterilization.

5. The air sterilizer as claimed in claim 4, further comprising a first memory means for storing the size of the target space and predetermined operating condition data corresponding to the size of the target space, wherein the control unit controls the operation of the ozone generating unit according to the operating condition data corresponding to the size of the target space by referencing the first memory means.

6. The air sterilizer as claimed in claim 4, wherein if the operation of the ozone generating unit according to the operating condition data is completed, the control unit performs control for change of the operating mode to the standby (cleaning) mode.

7. The air sterilizer as claimed in claim 4, wherein the logic circuit additionally calculates data on a time T_{P} from start of the operation of the ozone generating unit to when the concentration of ozone detected by the ozone sensor reaches the predetermined concentration, and the control unit controls the ozone generating unit such that the ON time ratio (R) is decreased if a ratio of the operating time (T) and the time (T_{P}) is below a predetermined value.

8. The air sterilizer as claimed in claim 1, further comprising:
a human body sensor for detecting a human body existing in the target space, and
a logic circuit unit for calculating sensor signals generated from the human body sensor and calculating data on the distance (D) from the human body sensor to the human body or data on the frequency (N) of detecting the human body in the target space.

9. The air sterilizer as claimed in claim 8, wherein the logic circuit unit operates to calculate the activity of human body (Y) by using the calculated data on the distance (D) and frequency (N), and the air sterilizer further comprises a second memory means for storing predetermined operating condition data corresponding to the calculated activity of human body (Y).

10. The air sterilizer as claimed in claim 9, wherein the control unit controls the operation of the ozone generating unit according to the operating condition data corresponding to the activity of human body (Y) by referencing the second memory means.

11. The air sterilizer as claimed in claim 5 or 10, wherein the operating condition data include one or more of data on the concentration of ozone (C) generated from the ozone generating unit, data on ozone generating during (TD) and data on an air volume (W).

12. The air sterilizer as claimed in claim 9, wherein the activity of human body (Y) satisfies the following formula:
$$Y ≅ \begin{matrix}D \\ N\end{matrix} * 100 ,$$
where D is the distance to the human body and N is the frequency of detecting the human body.

13. The air sterilizer as claimed in claim 10, wherein the operating condition data include one or more of data on the concentration of ozone (C) generated from the ozone generating unit, data on ozone generating during (TD) and data on an air volume (W).
